(19) United States
(12) Patent Application Publication
(10) Pub. No.: US 2013/0179774 A1
(43) Pub. Date: Jul. 11, 2013

(54) Method and apparatus for processing document conforming to docbase standard

(71) Applicant: Donglin Wang, Beijing (CN)

(72) Inventor: Donglin Wang, Beijing (CN)

(73) Assignee: SURSEN CORP., Beijing (CN)

(21) Appl. No.: 13/733,856

(22) Filed: Jan. 3, 2013

Related U.S. Application Data
(63) Continuation-in-part of application No. 12/868,330, filed on Aug. 25, 2010, now abandoned.
Application No. 12/868,330 is a continuation of application No. PCT/CN2009/070526, filed on Feb. 25, 2009.
Application No. PCT/CN2009/070526 is a continuation-in-part of application No. 12/133,309, filed on Jun. 4, 2008.
Application No. 12/133,309 is a continuation-in-part of application No. PCT/CN2006/003294, filed on Dec. 5, 2006.

(30) Foreign Application Priority Data
Dec. 5, 2006 (CN) 200510126683.6
Dec. 9, 2006 (CN) 200510131071.6
Feb. 25, 2008 (CN) 200810100890.8

(51) Int. Cl. G06F 17/21

(52) U.S. Cl. CPC G06F 17/218
USPC 715/234

(57) ABSTRACT

The present invention discloses a method and an apparatus for processing a document conforming to a docbase standard. The method includes: obtaining contents of a document conforming to a docbase standard via a docbase standard interface; generating an interim document which is in a format supported by a third-party software, and saving the contents of the document into the interim document as at least one embedded object and/or image; and providing the interim document for the third-party software for displaying. According to the method and the apparatus provided by the present invention, third-party software is able to process documents conforming to the docbase standard without any change.

### CROSS-REFERENCE TO RELATED APPLICATION

The application is a continuation in part of U.S. patent application Ser. No. 12/868,330, filed Aug. 15, 2010, which claims priority of PCT/CN2009/070526 (filed on Feb. 25, 2009), which claims priority of Chinese patent application 200810100890.8 (filed on Feb. 25, 2008); and the application is also a continuation in part of U.S. patent application Ser. No. 12/133,309 (filed on Jun. 4, 2008), which is a continuation-in-part of International Application No. PCT/CN2006/003294 (filed on Dec. 5, 2006), which claims priority to Chinese Application No. 200510126683.6 (filed Dec. 5, 2005), and 200510131071.6 (filed on Dec. 9, 2005), the entire contents of which are incorporated herein by reference.

### FIELD OF THE INVENTION

The present invention relates to docbase management system techniques, and particularly, to a method and apparatus for processing a document conforming to a docbase standard.

### BACKGROUND OF THE INVENTION

A docbase management system is a kind of platform software. It is a complicated software system providing basic functions for processing unstructured document (also referred to as unstructured data, unstructured information). The basic functions include creating, storing, reading and writing, parsing, presenting, organizing, managing, security controlling, searching and so on. The docbase management system also provides a standard interface for application software to invoke. The standard interface is referred to as a docbase standard interface or a standard interface of the docbase management system, and the standard of the standard interface is referred to as the docbase standard. Data stored in the docbase management system is referred to as a docbase, i.e. data accessible via the docbase standard interface. The data can also be referred to as a document conforming to the docbase standard, i.e., the storage format of the document is supported by in other manners. All operations that can be done on a document by the application software are converted into operations software conforming to the docbase standard. A previous patent application CN1979478 of the applicant provides a document processing system including a docbase management system, a storage and an application software. Data of the docbase management system is stored in the storage. The docbase management system and the application software are communicatively connected to each other through a docbase standard interface. The standard interface may be defined based on pre-defined actions and objects or defined on a pre-defined universal document model. The standard interface provides different operation functions on the document. The application software sends instructions to the docbase management system through invoking the standard interface, and the docbase management system performs corresponding operations on the document stored in the storage according to the instructions of the application software.

Currently, widely-used document editing software only supports one or several traditional document formats. The above document editing software is referred to as third-party software herein. Existing third-party software is unable to directly open a document conforming to the docbase standard (e.g. an Unstructured Operation Markup Language (UOML) document), and also unable to process the document, such as editing, saving and so on.

In order to enable the third-party software to process a document conforming to the docbase standard, a solution is to totally re-develop the third-party software to enable the third-party software to support the document conforming to a docbase standard (e.g. a UOML document). But this solution requires cooperation of vendors of the third-party software.

### SUMMARY OF THE INVENTION

Therefore, the present invention provides a method for processing a document conforming to the docbase standard, so as to enable third-party software to process the document conforming to the docbase standard without changing the third-party software.

In view of the above, technical schemes provided by the present invention are as follows.

A method for processing a document conforming to a docbase standard, comprising:

obtaining contents of a document conforming to a docbase standard via a docbase standard interface;

generating an interim document which is in a format supported by a third-party software, and saving the contents of the document into the interim document as at least one embedded object and/or image; and

providing the interim document for the third-party software for displaying.

An apparatus for processing a document conforming to a docbase standard, comprising:

a first module, adapted to obtain contents of a document conforming to a docbase standard via a docbase standard interface;

a second module, adapted to generate an interim document in a format supported by the third-party software and save the contents of the document into the interim document as at least one embedded object and/or image

a third module, adapted to provide the interim document for a third-party software for displaying.

A computer-readable medium having instructions stored thereon that when executed cause a computing system to process a document conforming to a docbase standard by:

obtaining contents of a document conforming to a docbase standard via a docbase standard interface;

generating an interim document which is in a format supported by the third-party software, and saving the contents of the document into the interim document as at least one embedded object and/or image; and

providing the interim document for a third-party software for displaying.

It can be seen from the above that, when the third-party software opens a document conforming to a docbase standard, the apparatus provided by the present invention may invoke a docbase standard interface to parse the original document, obtain contents of the original document, and generate an interim document based on the contents obtained and provide the interim document to the third-party software for displaying. The interim document conforms to a format supported by the third-party software. As such, the third-party software is enabled to recognize the interim document and converted contents in the interim document. Therefore, after opening the interim document, the third-party software can display the converted contents to present the contents of the original document. As described above, the third-party software can process the original document with aid of a plug-in, thus implements processing of a document conforming to a docbase standard without cooperation of a vendor of the third-party software. Simply speaking, by using the scheme, the third-party software opens and saves the document conforming to a docbase standard by invoking the apparatus provided by the present invention, but edits the document by itself, so no change of the third-party software is needed.

### BRIEF DESCRIPTION OF THE DRAWINGS

FIG. 1 is a flowchart illustrating a method for processing a document conforming to a docbase standard by third-party software according to an embodiment of the present invention.

FIG. 2 is a flowchart illustrating a detailed method for processing a document conforming to a docbase standard by third-party software according to an embodiment of the present invention.

### DETAILED DESCRIPTION OF THE INVENTION

The present invention will be described in detail hereinafter with reference to accompanying drawings and embodiments to make the technical solution and merits therein clearer.

The docbase management system is a universal technical platform with all kinds of document processing functions and an application issues an instruction to the docbase management system via an interface layer to process a document, then the docbase management system performs corresponding operation according to the instruction. In this way, as long as different applications and docbase management systems follow the same standard, different applications can process a same document through a same docbase management system, therefore document interoperability is achieved. Similarly, one application may process different documents through different docbase management systems without independent development on every document format.

Furthermore, the technical scheme of the present invention provides a universal document model which makes different applications compatible with different documents to be processed. The interface standard is based on the document model so that different applications can process a same document via the interface layer. The universal document model can be applied to all types of document formats so that one application may process documents in different formats via the interface layer. In one embodiment, the document model is obtained by modeling the appearance information of documents. The interface standard defines various instructions based on the universal document model for operations on corresponding documents and the way of issuing instructions by an application to a docbase management system(s). The docbase management system has functions to implement the instructions from the application. The universal model includes multiple hierarchies such as a docset including a number of documents, a docbase and a document warehouse. And the interface standard includes instructions covering organization management, query and security control, of multiple documents. In the universal model, a page is separated into multiple layers from bottom to top and the interface standard includes instructions for operations on the layers, storage and extraction of a source file corresponding to a layer in a document. In addition, the docbase management system has information security management control functions for documents, e.g., role-based fine-grained privilege management, and corresponding operation instructions are defined in the interface standard.

According to the present invention, the application layer and the data processing layer are separated with each other. An application no longer needs to deal with document formats directly and a document format is no longer associated with a specific application. Therefore a document can be processed by different applications and an application can process documents in different formats and document interoperability is achieved. The whole document processing system can further process multiple documents instead of one document. When a page in a document is divided into multiple layers, different management and control policies can be applied to different layers to facilitate operations of different applications on the same page (it can be designed that different applications manage and maintain different layers) and further facilitate source file editing and it is also a good way to preserve the history of editing.

The document processing system in which the method and system for security management of the present invention are applied is explained in detail as followings

The document processing system in accordance with the present invention includes an application, an interface layer, a docbase management system and a storage device.

The application includes any of existing document processing and contents management applications in the application layer of the document processing system, and the application sends an instruction in compliance with the interface standard to process documents. All operations are applied on documents in compliance with the universal document model regardless of the storage formats of the documents.

The interface layer is in compliance with the interface standard for interaction between the application layer and the docbase management system. The application layer sends standard an instruction to the docbase management system via the interface layer and the docbase management system returns the result of corresponding operation to the application layer via the interface layer. It can be seen that, since all applications can sends a standard instruction via the interface layer to process a document in compliance with the universal document model, different applications can process a same document through a same docbase management system and a same application can process documents in different formats through different docbase management systems.

Preferably, the interface layer includes an upper interface unit and a lower interface unit. The application layer can send a standard instruction from the upper interface unit to the lower interface unit and the docbase management system receives the standard instruction from the lower interface unit. The lower interface unit is further used for returning the result of the operation performed by the docbase management system to the application system through the upper interface unit. In practical applications, the upper interface unit can be set up in the application layer and the lower interface unit can be set up in the docbase management system.

The docbase management system is the core layer of the document processing system and performs an operation on a document according to a standard instruction from the application through the interface layer.

The storage device is the storage layer of the document processing system. A common storage device includes a hard disk or memory, and also can include an optical disk, flash memory, floppy disk, tape, remote storage device, or any kind of device that is capable of storing data. The storage device stores multiple documents and the way of storing the documents is irrelevant to applications.

It can thus be seen that the present invention enables the application layer to be separated from the data processing layer in deed. Documents are no longer associated with any specified applications and an application no longer needs to deal with document formats. Therefore different applications can edit a same document in compliance with the universal document model and satisfactory document interoperability is achieved among the applications.

The system for processing the document may comprise an application and a platform software (such as docbase management system). The application performs an operation on abstract unstructured information by issuing one or more instructions to the platform software. The platform software receives the instructions, maps the operation on abstract unstructured information to the operation on storage data corresponding to the abstract unstructured information, and performs the operation on the storage data. It is noted that the abstract unstructured information are independent of the way in which the storage data are stored.

Storage data refer to various kinds of information maintained or stored on a storage device (e.g., a non-volatile persistent memory such as a hard disk drive, or a volatile memory) for long-term usage and such data can be processed by a computing device. The storage data may include complete or integrated information such as an office document, an image, or an audio/video program, etc. The storage data are typically contained in one disk file, but such data may also be contained in multiple (related) files or in multiple fields of a database, or an area of an independent disk partition that is managed directly by the platform software instead of the file system of the OS. Alternatively, storage data may also be distributed to different devices at different places. Consequently, formats of the storage data may include various ways in which the information can be stored as physical data as described above, not just formats of the one or more disk files.

Storage data of a document can be referred to as document data and it may also contain other information such as security control information or editing information in addition to the information of visual appearance (appearance information) of the document. A document file is the document data stored as a disk file.

Here, the word “document” refers to information that can be printed on paper (e.g., static two-dimension information). It may also refer to any information that can be presented, including multi-dimension information or stream information such as audio and video.

In some embodiments, an application performs an operation on an (abstract) document, and it needs not to consider the way in which the data of the document are stored. A platform software (such as a docbase management system) maintains the corresponding relationship between the abstract document and the storage data (such as a document file with specific format), e.g., the platform software maps an operation performed by the application on the abstract document to an operation actually on the storage data, performs the operation on the storage data, and returns the result of such operation back to the application when the return of the result is requested.

In some embodiments, the abstract document can be extracted from the storage data, and different storage data may correspond to the same abstract document. For example, when the abstract document is extracted from visual appearance (also called layout information) of the document, different storage data having the same visual appearance, no matter the ways in which they are stored, may correspond to the same abstract document. For another example, when a Word file is converted to a PDF file that has same visual appearance, the Word file and the PDF file are different storage data but they correspond to the same abstract document. Even when the same document is stored in different versions of Word formats, these versions of Word files are different storage data but they correspond to the same abstract document.

In some embodiments, in order to record the visual appearance properly, it would be better to record position information of visual contents, such as text, image and graphic, together with resources referenced, such as linked pictures and nonstandard fonts, to ensure fixed position of the visual contents and to guarantee that the visual contents is always available. A layout-based document meets the above requirements and is often used as storage data of the platform software.

The storage data created by platform software is called universal data since it is accessible by standard instructions and can be used by other applications that conform to the interface standard. Besides universal data, an application is also able to define its own unique data format such as office document format. After opening and parsing a document with its own format, the application may request creating a corresponding abstract document by issuing one or more standard instructions, and the platform software creates the corresponding storage data according to the instructions. Although the format of the newly created storage data may be different from the original data, the newly created storage data, the universal data, corresponds to the same abstract document with the original data, e.g., it resembles the visual appearance of the original data. Consequently, as long as any document data (regardless of its format) corresponds to an abstract document, and the platform software is able to create a storage data corresponding to the abstract document, any document data can be converted to an universal data that corresponds to same abstract document and is suitable to be used by other applications, thus achieving document interoperability between different applications conforms to the same interface standard.

For a non-limiting example, an interoperability process involving two applications and one platform software is described below. The first application creates first abstract document by issuing a first set of instructions to the platform software, and the platform software receives the first set of instructions from the first application and creates a storage data corresponding to the first abstract document. The second application issues a second set of instructions to the platform software to open the created storage data, and the platform software opens and parses the storage data according to the second set of instructions, generating second abstract document corresponding to the said storage data. Here, the second abstract document is identical to or closely resembles the first abstract document and the first and second sets of instructions conform to the same interface standard, making it possible for the second application to open the document created by first application.

For another non-limiting example, another interoperability process involving one application and two platform software is described below. The first platform software parses first storage data in first data format, generates a first abstract document corresponding to the storage data. The application retrieves all information from the first abstract document by issuing a first set of instructions to the first platform software. The application creates a second abstract document which is identical to or closely resembles the first abstract document by issuing a second set of instructions to the second platform software. The second platform creates second storage data in second data format according the second set of instructions. Here, the first and second sets of instructions conform to the same interface standard, enabling the application to convert data between different formats and retain the abstract feature unchanged. The interoperability process involving multiple applications and multiple platform software can be deduced from the two examples above.

Due to limiting factors such as document formats and functions of relative software, the storage data may not be mapped to the abstract document with 100% accuracy and there may be some deviations. For a non-limiting example, such deviations may exist regardless of the precision floating point numbers or integers used to store coordinates of the visual contents. In addition, there may be deviations between the displaying/printing color and the predefined color if the software used for displaying/printing lacks necessary color management functions. If these deviations are not significant, for non-limited examples, a character's position deviated 0.01 mm from where it should be, or an image with lossy compression by JPEG, these deviations can be ignored by users. The degree of deviation accepted by the users is related to practical requirements and other factors, for example, a professional art designer would be stricter with the color deviation than most people. Therefore, the abstract document may not be absolutely consistent with the corresponding storage data and displaying/printing results of different storage data corresponding to the same abstracted visual appearance may not be absolutely same with each other. Even if same applications are used to deal with the same storage data, the presentations may not be absolutely the same. For example, the displaying results under different screen resolutions may be slightly different. In the present invention, “similar” or “consistent with” or “closely resemble” is used to indicate that the deviation is acceptable, (e.g., identical beyond a predefined threshold or different within a predefined threshold). Therefore, storage data may correspond to, or be consistent with, a plurality of similar abstract documents.

The corresponding relationship between the abstract document and the storage data can be established by the platform software in many different ways. For example, the corresponding relationship can be established when opening a document file, the platform software parses the storage data in the document file and forms an abstract document to be operated by the application. Alternatively, the corresponding relationship can be established when platform software receives an instruction indicating creating an abstract document from an application, the platform software creates the corresponding storage data. In some embodiments, the application is aware of the storage data corresponding to the abstract document being processed (e.g., the application may inform the platform software where the storage data are, or the application may read the storage data into memory and submit the memory data block to the platform software). In some other embodiments, the application may “ignore” the storage data corresponding to the operated abstract document. For a non-limiting example, the application may require the platform software to search on Internet under certain condition and open the first searched documents.

Generally speaking, the abstract document itself is not stored on any storage device. Information used for recording and describing the abstract document can be included in the corresponding storage data or the instruction(s), but not the abstract document itself. Consequently, the abstract document can be called alternatively as a virtual document.

In some embodiments, the abstract document may have a structure described by a document model, such as a universal document model described hereinafter. Here, the statement “document data conform to the universal document model” means that the abstract document extracted from the document data conforms to the universal document model. Since the universal document model is extracted based on features of paper, any document which can be printed on a paper conforms to the document model, making such document model “universal”.

In some embodiments, other information such as security control, document organization (such as the information about which docset a document belongs to), invisible information like metadata, interactive information like navigation and thread, can also be extracted from the document data in addition to visual appearance of the document. Even multi-dimension information or stream information such as audio and video can be extracted. All those extracted information can be referred to jointly as abstract information. Since there is no persistent storage for the abstract information, the abstract information also can be referred to as virtual information. Although most of embodiments of the present invention are based on the visual appearance of the document, the method described above can also be adapted to other abstract information, such as security control, document organization, multi-dimension or stream information.

There are various ways to issue the instruction used for operating on the abstract information, such as issuing a command string or invoking a function. An operation on the abstract information can be denoted by instructions in different forms. The reason why invoking a function is regarded as issuing the instruction is that addresses of difference functions can be regarded as different instructions respectively, and parameter(s) of the function can be regarded as parameter(s) of the instruction. When the instruction is described under “an operation action+an object to be operated” standard, the object in the instruction may either be the same or different from an object of the universal document model. For example, when setting the position of a text object of a document, the object in the instruction may be the text object, which is the same as the object of the universal document model, or it may be a position object of the text which is different with the object of the universal document model. In actual practice, it will be convenient to unify the objects of the instructions and the objects of universal document model.

The method described above is advantageous for document processing as it separates the application from the platform software. In practice, the abstract information and the storage data may not be distinguished strictly, and the application may even operate on the document data directly by issuing instruction to the platform software. Under such a scenario, the instruction should be independent of formats of the document data in order to maintain universality. More specifically, the instruction may conform to an interface standard independent of the formats of the document data, and the instruction may be sent through an interface layer which conforms to the interface standard. However, the interface layer may not be an independent layer and may comprise an upper interface unit and a lower interface unit, where the upper interface unit is a part of application and the lower interface unit is a part of platform software.

The embodiments of the document processing system provided by the present invention are described hereinafter.

The universal document model can be defined with reference to the features of paper since paper has been the standard means of recording document information, and the functions of paper are just enough to satisfy the needs of practical applications in work and living.

If a page in a document is regarded as a piece of paper, all information put down on the paper should be recorded, so the universal document model which is able to describe all visible contents on the page is demanded. The page description language (e.g., PostScript) in the prior art is used for describing all information to be printed on the paper and will not be explained herein. However, the visible contents on the page can always be categorized into three classes: characters, graphics and images.

When the document uses a specific typeface or character, corresponding font shall be embedded into the documents to guarantee identical output on screens/printer of different computers. The font resources shall be shared to improve storage efficiency, i.e., only one font needs to be embedded when a same character is used for different places. An image sometimes may be used in different places, e.g., the image may be used as the background images of all pages or as a frequently appearing company logo and it will be better to share the image, too.

Obviously, as a more advanced information process tool, the universal document model not only imitates paper, but also develops some enhanced digital features, such as metadata, navigation, thread, minipage, etc. Metadata includes data used for describing data, e.g., the metadata of a book includes information of author, publishing house, publishing date and ISBN. Metadata is a common term in the industry and will not be explained further herein. Navigation includes information similar to the table of contents of a book, and navigation is also a common term in the industry. The thread information describes the location of a passage and the order of reading, so that when a reader finishes a screen, the reader can learn what information should be displayed on the next screen. The thread also enables automatic column shift and automatic page shift without manually appointing a position by the reader. Minipage includes miniatures of all pages and the miniatures are generated in advance, the reader may choose a page to read by checking the miniatures.

The universal document model includes multiple layers including a document warehouse, docbase, docset, document, page, layer, object group and layout object.

The document warehouse consists of one or multiple docbases, and the relation among docbases is not as strictly regulated as the relation among hierarchies within a docbase. Docbases can be combined and separated simply without modifying the data of the docbases, and usually no unified index is set up for the docbases (especially a fulltext index), so most of operations on document warehouse search traverse the indexes of all the docbases without an available unified index. Every docbase consists of one or multiple docsets and every docset consists of one or multiple documents and possibly a random number of sub docsets. A document includes a normal document file (e.g., a .doc document) in the prior art and the universal document model may define that a document may belong to one docset only or belong to multiple docsets. A docbase is not a simple combination of multiple documents but a tight organization of the documents, especially the great convenience can be brought after unified query indexes are established for the document contents.

Every document consists of one or multiple pages in an order (e.g., from the front to the back), and the cores of the pages may be different. A page core may be even not in a rectangle shape but in a random shape expressed by one or multiple closed curves.

Further a page consists of one or multiple layers in an order (e.g., from the top to the bottom), and one layer is overlaid with another layer like one piece of glass over another piece of glass. A layer consists of a random number of layout objects and object groups. The layout objects include statuses (typeface, character size, color, ROP, etc.), characters (including symbols), graphics (line, curve, closed area filled with specified color, gradient color, etc.), images (TIF, JPEG, BMP, JBIG, etc.), semantic information (title start, title end, new line, etc.), source file, script, plug-in, embedded object, bookmark, streaming media, binary data stream, etc. One or multiple layout objects can form an object group, and an object group can include a random number of sub object groups.

The docbase, docset, document, page and layer may further include metadata (e.g., name, time of latest modification, etc., the type of the metadata can be set according to practical needs) and/or history. The document may further include navigation information, thread information and minipage. And the minipage may be placed in the page or the layer. The docbase, docset, document, page, layer and object group may also include digital signatures. The semantic information had better follow layout information to avoid data redundancy and facilitates the establishment of the relation between the semantic information and the layout. The docbase and document may include shared resources such as a font and image.

Further the universal document model may define one or multiple roles and grant certain privileges to the roles. The privileges are granted based on units including a docbase, docset, document, page, layer, object group and metadata. Privileges define whether a role is authorized to read, write, copy or print any one or any combination of the above units.

The universal document model is beyond the conventional way of one document for one file. A docbase includes multiple docsets and a docset includes multiple documents. Fine-grained access and security control is applied to document contents in the docbase so that even an individual character or rectangle can be accessed in the docbase while the prior document management system can only access as far as file name.

The organization structures of the objects are tree structures and are developed layer by layer into smaller objects.

The document warehouse object consists of one or multiple docbase objects (not shown in the drawings).

The docbase object includes one or multiple docset objects, a random number of docbase helper objects and a random number of docbase shared objects.

The docbase helper object includes: a metadata object, role object, privilege object, plug-in object, index information object, script object, digital signature object and history object etc. The docbase shared object includes an object that may be shared among different documents in the docbase, such as a font object and an image object.

Every docset object includes one or multiple document objects, a random number of docset objects and a random number of docset helper objects. The docset helper object includes a metadata object, digital signature object and history object. When the docset object includes multiple docset objects, the structure of the object is similar to the structure of a folder including multiple folders in the Windows system.

Every document object includes one or multiple page objects, a random number of document helper objects and a random number of document shared objects. The document helper object includes a metadata object, font object, navigation object, thread object, minipage object, digital signature object and history object. The document shared object includes an object that may be shared by different pages in the document, such as an image object and a seal object.

Every page object includes one or multiple layer objects and a random number of page helper objects. The page helper object includes a metadata object, digital signature object and history object.

Every layer object includes one or multiple layout objects, a random number of object groups and a random number of layer shared objects. The layer helper object includes a metadata object, digital signature object and history object. The object group includes a random number of layout objects, a random number of object groups and optional digital signature objects. When the object group includes multiple object groups, the structure of the object is similar to the structure of a folder including multiple folders in the Windows system.

The layout object includes a status object, character object, line object, curve object, arc object, path object, gradient color object, image object, streaming media object, metadata object, note object, semantic information object, source file object, script object, plug-in object, binary data stream object, bookmark object and hyperlink object.

Further the status object includes a random number of character set objects, typeface objects, character size objects, text color objects, raster operation objects, background color objects, line color objects, fill color objects, linetype objects, line width objects, line joint objects, brush objects, shadow objects, shadow color objects, rotate objects, outline typeface objects, stroke typeface objects, transparent objects and render objects.

The universal document model can be enhanced or simplified based on the above description practically. If a simplified document model does not include a docset object, the docbase object shall include a document object directly. And if a simplified document model does not include a layer object, the page object shall include a layout object directly.

A skilled in the art can understand that a minimum universal document model includes only a document object, page object and layout object. And the layout object includes only a character object, line object and image object. The models between a full model and the minimum model are included in the equivalents of the preferred embodiments of the present invention.

The docbase management system may store and organize the data of the docbase in any form, e.g., the docbase management system may save all files in a docbase in a file on a disk, or create one file on the disk for one document and organize the documents by using the file system functions of the operating system, or create one file on the disk for one page, or allocate room on disk and manage the disk tracks and sectors without referencing to the operating system. The docbase data can be saved in a binary format, in XML, or in binary XML. The page description language (used for defining objects including texts, graphics and images in a page) may adopt PostScript, or PDF, or SPD, or a customized language. To sum up, any definition method that enables the interface standard to achieve the functions described herein is acceptable.

In the embodiment, the application requests to process a document through a unified interface standard (e.g., UOML interface). The docbase management systems may have different models developed by different manufacturers, but the application developers always use the same interface standard so that the docbase management systems of any model from any manufacturer are compatible with the application. The application e.g., Red Office, OCR, webpage generation software, musical score editing software, Sursen Reader, Microsoft Office, or any other reader applications, instructs a docbase management system via the UOML interface to perform an operation. Multiple docbase management systems may be employed, shown in FIG. 10 as DCMS 1, DCMS 2 and DCMS 3. The docbase management systems process documents conforming with the universal document model, e.g., create, save, display and present documents, according to a unified standard instruction from the UOML interface. In the present invention, different applications may invoke the same docbase management system at the same time or at different time, and the same application may invoke different docbase management systems at the same time or at different time.

In one embodiment of the present invention, a method for processing content of a document includes: modeling the content of the document as an abstract document that conforms to based on a universal document model, wherein the abstract document corresponds to more than one files in different that is independent of the storage formats of the document having the same visual appearance; issuing an instruction describing an operation on the content of the abstract document independent of the storage formats of the document to a docbase management system; and receiving said instruction and performing the operation on storage data of one of the files corresponding storage data corresponded to the content of the abstract document according to said instruction.

A method of processing visible document content, comprising: In one embodiment of the present invention, a method for processing content of a document includes: issuing an instruction describing an operation on visible content on pages of a first document independent of the format of the first document to a first docbase management system; performing the operation on storage data corresponded to the visible content on pages of said first document and returning information in a form defined by the instruction by said first docbase management system; issuing the same instruction describing the same operation on visible content on pages of a second document independent of the format of the second document to a second docbase management system; performing the same operation on storage data corresponded to the visible content on pages of said second document and returning information in the same form defined by the same instruction; wherein, the first document and the second document are stored in different formats, wherein the same visible content on pages of the first document and the second document are modeled based on a universal document model that is independent of the formats of the first and the second documents.

The basic idea of the present invention lies in that, when being informed that third-party software needs to open a document which conforms to a docbase standard, software which supports the docbase standard converts the format of the document into a format supported by the third-party software and provides the converted document for being processed by the third-party software.

The software may be a plug-in, a controller or a set of independent application software pre-configured in the third-party software. For facilitating description, the document conforming to the docbase standard which is to be processed by the third-party software is referred to as an original document, and a docbase standard interface is referred to as a standard interface.

Those skilled in the art can understand, in the following embodiments of the present invention, the process how a docbase management system works with an application to process a document is described clearly above, and the interaction between the third-party software and the docbase management is the same. So for facilitating description, in the following embodiments, the interaction between the third-party software and the docbase management is not described in detail.

The method provided by an embodiment of the present invention may include: obtaining contents of an original document via a standard interface, generating an interim document, and providing the interim document for a third-party software to display, wherein the format of the interim document is supported by the third-party software.

The apparatus provided by an embodiment of the present invention may include: a first module, adapted to obtain contents of an original document via a standard interface; a second module, adapted to generate an interim document; and a third module, adapted to provide the interim document for a third-party software to display; wherein the format of the interim document is supported by the third-party software. The apparatus may further include a fourth module, adapted to save, after the interim document is edited by the third-party software, contents edited into the original document via the standard interface, and a fifth module, adapted to embed the interim document edited into the original document, or embed contents edited in the interim document into the original document in the format of the interim document.

The present invention will be described hereinafter by taking setting a plug-in in a third-party software as an example. Those skilled in the art should know that other manners may also be used for implementing the present invention by make moderate modifications to the following embodiment.

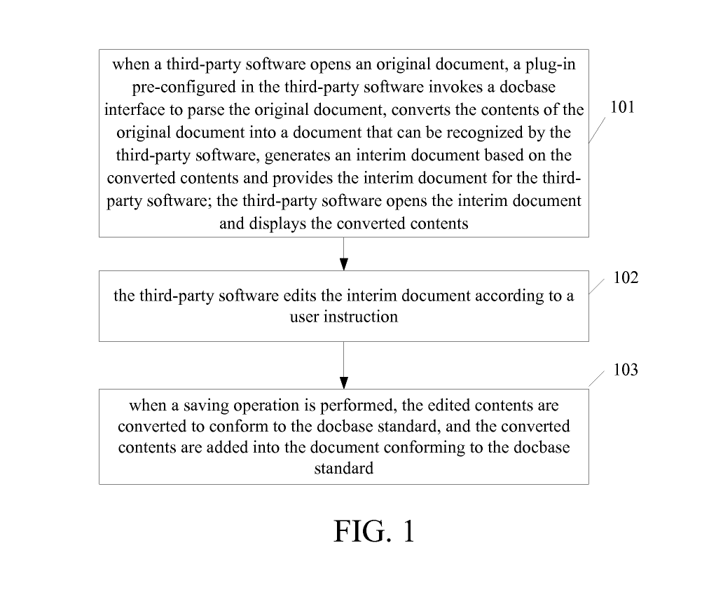

FIG. 1 is a flowchart illustrating a method for processing a document conforming to the docbase standard by a third-party software. As shown in FIG. 1, the method may include the steps as follows.

In step 101, when a third-party software opens an original document, a plug-in which is pre-configured in the third-party software and supports the docbase standard obtains contents of the original document and generates an interim document according to the contents obtained. The format of the interim document is supported by the third-party software. The third-party software opens the interim document and displays the contents converted. The process of obtaining the contents of the original document and generating the interim document may include: the plug-in invokes a standard interface to parse the original document, converts the contents of the original document into contents that can be recognized by the third-party software, and generates the interim document based on the contents converted; or the plug-in invokes the standard interface to directly obtain contents of the original document, whose format is supported by the third-party software.

The plug-in supporting the docbase standard refers to a plug-in program capable of invoking the docbase standard interface. The standard interface may be invoked by issuing an instruction string, e.g. “<UOML_INSERT (OBJ=PAGE, PARENT=123.456.789, POS=3)/>”, to the docbase management system. The instruction string can be generated according to a pre-defined standard format. The standard interface may also be some interface functions having standard names and parameters, e.g. “BOOL UOI_InsertPage (UOI_Doc*pDoc, int nPage)”, and invoking such standard interface by the plug-in can be through issuing a standard instruction defined by the interface function to the docbase management system.

The design and development of the plug-in is independent from that of the third-party software, as long as the plug-in is able to interact with the third-party software through a plug-in interface provided by the third-party software. For example, when needing to open a document conforming to the docbase standard, a third-party software may trigger the plug-in via the plug-in interface of the third-party software to obtain and parse the document.

This step realizes operations of opening and displaying the original document in the third-party software. the pre-configured plug-in firstly invokes a docbase standard interface to parse the original document, converts the original document into contents that can be recognized by the third-party software, then creates an interim document for storing the contents converted. The format of the interim document is supported by the third-party software. Therefore, the third-party software is able to open the interim document and display the contents converted, thereby displaying the contents of the original document. The displaying operation may be implemented by object linking and embedding or by directly converting the contents into imaged for display.

After the original document is displayed, preferably, if the third-party software has editing functions, it may edit and save the document according to user instructions. Specifically, the following steps may be performed.

In step 102, the third-party software edits the interim document according to a user instruction.

In this step, the third-party software may perform various editing operations on the interim document, including text editing, graphics editing and image editing.

In step 103, when saving the interim document, the third-party software triggers the plug-in via the plug-in interface to convert the contents edited to conform to the docbase standard and then to add the contents converted into the original document. Herein, the process of the third-party software triggering the plug-in is similar to that for opening the document.

In this step, when saving the edited document, the contents edited are converted into the format conforming to the docbase standard, and then the converted contents are added into the original document, so as to form an edited document conforming to the docbase standard.

As described above, the method of the present invention makes it possible for the third-party software to process, including opening, editing and saving, the document conforming to the docbase standard.

Hereinafter, the method of the present invention will be described with reference to an embodiment. In the following embodiment, UOML is taken as an exemplary docbase standard.

UOML is a detailed docbase standard having been proposed currently. It includes a series of standards defined by UOML technical committee of Organization for the Advancement of Structured Information Standards (OASIS), and is also an industry standard with No. S07020-T approved by China Information Industry Ministry. The UOML standard provides an interoperable manner to reduce development costs and information exchanging costs of enterprises. The UOML is a document processing language based on XML, and is platform-irrelevant, programming language-irrelevant and application-irrelevant. It defines universal functions for processing documents and abstracts operations on fixed-layout files. An UOML document refers to a document that can be accessed via the UOML standard, and is short for UOML-accessible document.

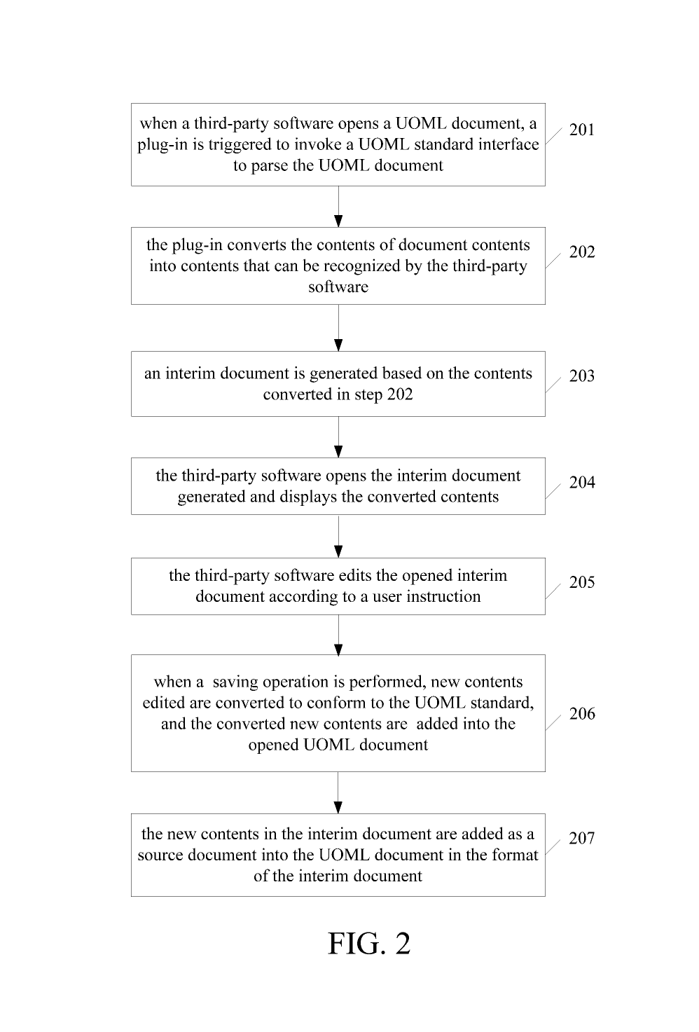

FIG. 2 is a flowchart illustrating a detailed method for processing a document conforming to a docbase standard by a third-party software according to an embodiment of the present invention. In order to implement various operations on an original document, a docbase management system supporting the docbase standard should be installed. The docbase management system may be implemented in various manners, e.g. adopting a stand-alone docbase management system or a server docbase management system, and the implementation manner adopted is not restricted herein.

As shown in FIG. 2, the method may include the steps as follows.

In step 201, when a third-party software opens an original document, a plug-in is triggered to invoke a docbase standard interface to parse the original document.

The plug-in is a program developed in advance for implementing operations such as conversion between a third-party software-supported document and the original document. It interacts with the third-party software through a plug-in interface provided by the third-party software. Before being used, the plug-in needs to be configured in the third-party software. The third-party software triggers the plug-in to start work by issuing an instruction for opening the original document.

That the plug-in supports the docbase standard means the plug-in can invoke a docbase standard interface to parse the original document. For example, the plug-in may firstly invoke a UOML standard interface for verifying document format so as to determine whether the original document to be opened is a UOML document. If the original document is not a UOML document, an error prompt will be provided. If the original document is a UOML document, a standard interface for parsing document will be invoked to parse contents of the original document.

In the above, the method described in the patent application with a publication number of CN 1979487 may be adopted for invoking the UOML standard interfaces.

In step 202, the plug-in converts the contents of the original document into contents that can be recognized by the third-party software.

As described above, in order to display the original document, an object embedding manner can be adopted, i.e., the contents of the original document is stored as one or more objects to be embedded in an interim document. Or, an image display manner can be adopted, i.e., the contents of the original document is converted into one or more images to be stored into the interim document.

Storing the contents of the original document into the interim document as the embedded objects may be implemented by an object linking and embedding technique, or by a direct data embedding method, etc. The object linking and embedding technique supports displaying, in a document of a certain format, contents in another format, i.e., embedding, into the document of a certain format, the contents in another format by means of linking.

Since there are the above two different manners, the converted contents in this step may also be divided into two categories: embedded objects and image objects. Herein, the embedded objects can be generated and parsed by the docbase management system.

When the object embedding technique is adopted, the converted objects may vary according to operation platforms. Generally, document contents will be converted into Object Linking and Embedding (OLE) objects in a Windows platform, Kpart objects in a Kool Desktop Environment (KDE) platform, and BABOON objects in a GNU Network Object Model Environment (Gnome) platform. According to the object linking and embedding technique, different operation platforms have the same converting procedure. Herein, the detailed converting procedure will be described by taking converting document contents into OLE objects in a Windows platform as an example. The procedure may include: a plug-in generates one or more OLE objects by converting the contents of the document parsed in step 201. E.g. the contents in each page of a UOML document is converted into an OLE object, and then information of the contents parsed is stored into the OLE object. Preferably, the OLE object may further store information of software which parses the OLE object, e.g. information of the docbase management system, or an identifier of an application software capable of parsing and displaying documents conforming to the docbase standard, and so on.

Specifically, the information of the parsed contents stored in the OLE object may be various types of information, e.g. position information of the document contents, data of the page or a compressed package of the document contents, etc.

Storing the position information of the document contents in the OLE object is to insert a link of the document contents, e.g. a link to a document name and a page number, for specifying the location of the document contents in the OLE object. When the third-party software needs to display the contents of the OLE object, it may invoke a software capable of displaying the document conforming to the docbase standard (e.g. a UOML reader, hereinafter referred to as a presentation software) to obtain data of the document contents according to the link, parse the data and display the parsed document contents on a display position designated by the third-party software. The parsing of the data performed by the presentation software may be implemented by invoking a docbase management system.

Storing page data into an OLE object is to directly embed data of the document contents into the OLE object. When needing to display the contents of the OLE object, the third-party software may invoke the presentation software to parse the data, and display the parsed document contents on a display position designated by the third-party software. The presentation software may implement the above parsing operation by invoking a docbase management system.

Storing a compressed package information of compressed document contents into an OLE object is to compress the data of the document contents and store the compressed data into the OLE object, which reduces the size of the OLE object and thus reduces the size of the interim document. When the OLE object is to be displayed, the compressed package is firstly de-compressed, then the presentation software is invoked to parse and display the data obtained by de-compressing. The presentation software may implement the parsing operation by invoking the docbase management system.

When the image display manner is adopted, layout information of a relevant portion of the document is obtained in this step via the docbase standard interface. Then, the layout information is recorded in an image, i.e. the layout information is stored as an image, and then the image is stored in the interim document, e.g., contents in a page of the original document may be converted into one image. For example, the plug-in may obtain a layout bitmap in a designated bitmap format for a specified page, i.e. a bitmap having the same presentation effect of the page, through an instruction for obtaining layout bitmap. There is no need to parse and process each layout object. In other words, the plug-in may directly obtain an exact layout bitmap without retrieving each layout object on the page and analyzing the meaning of the object and presenting the object on the layout. Thus, the plug-in utilizes the layout bitmap obtained to form the interim document in a format supported by the third-party software.

Specifically, during the above converting procedure, each page of the original document may be converted according to the methods described above.

Through this step, the document contents of the original document have been converted into contents in a format that could be recognized by the third-party software. Since the document contents are processed by the third-party software in a unit of document, the converted object should be saved in a document for being processed by the third-party software.

In this step, the plug-in may preferably obtain layer information or edition information of a document from the docbase. Each page of the document may include multiple layers and each layer may be edited by a different user. A user may need to process one or several of the layers, while other layers are kept invisible to the user. Or, a user may need to process a certain edition of the document, i.e. contents of the document saved by a certain user on a certain occasion. Thus, the plug-in may display information of all layers or information of all editions to the user. For example, it is possible to display the saving time, the user who carries out the saving, or content abstract, of each layer or each edition of the document so that the user can select a layer or edition required. Then the contents of the selected layer or edition of the document are converted to generate contents recognizable for the third-party software.

In step 203, an interim document is generated based on the converted contents in step 202.

The format of the interim document generated in this step is supported by the third-party software. Generally, the following formats may be adopted: Rich Text Format (RTF), Open Document Format (ODF), Unified Office document Format (UOF) and OpenXML format. The above formats may be adopted by the interim document for their universalities, but other formats may also be adopted as long as they are supported by the third-party software.

Take the RTF as an example. The detailed method for generating an interim document may be as follows: creating a document in the RTF format (referred to as an RTF document hereinafter for short), inserting all contents into the RTF document according to interrelationships among the positions of the contents converted in step 202. For example, in step 202, document contents on each page are converted into an OLE object, thus in this step, the OLE object converted from the document contents on the first page is inserted at the beginning of the RTF document, and then OLE objects converted from document contents on other pages are inserted subsequently.

In step 204, the plug-in provides the interim document for the third-party software. The third-party software opens the interim document and displays the converted objects.

Since the format of the interim document is supported by the third-party software, the third-party software is able to open the interim document. When displaying the objects in the interim document, different display manners may be adopted for different types of objects.

Specifically, if the object embedding manner is adopted, the converted contents are objects for object linking and embedding such as the OLE objects. The following takes the OLE object as an example to explain the display of this kind of object. The display procedure may include: invoking a software which is able to parse and display a docbase standard document when an OLE object is to be displayed, obtaining layout information of document contents corresponding to the OLE object, displaying and/or printing the document contents. When invoking a docbase standard interface, if the OLE object includes information of a presentation software, the presentation software may be invoked according to the information to parse and display the document contents stored in the OLE object. Specifically, when displaying the document contents according to content information stored in the OLE object, document contents corresponding to the content information may be retrieved according to the manner adopted in step 202 for storing information of the document contents. For example, if the OLE object stores the position information, i.e., a link to a document name and page number of the document contents is stored in step 202, when displaying the document contents, the presentation software finds out the location of the document contents to be displayed based on the link to the document name and the page number, parses and displays the data of the page corresponding to the OLE object. The presentation software may implement the parsing operation by invoking a docbase management system.

If the image display manner is adopted, the converted contents are images, e.g. layout bitmaps. When displaying the converted contents, the third-party directly paints the document contents according to the image data stored.

Both the above two manners can be adopted for the display of the document contents. When the object linking and embedding manner is adopted, the converted objects require less storage space, but the software capable of displaying the original document, i.e. the presentation software, is required in the system. When the image displaying manner is adopted, there will be a large amount of data after the conversion, which may occupy mass storage space, but the above presentation software, e.g. UOML reader, is not required, and the object data can be displayed directly.

Through the steps 201 to 204, functions of opening and displaying the original document in the third-party software can be implemented. Implementation of functions such as editing and saving the original document opened by the third-party software will be described in detail hereinafter.

In step 205, the third-party software edits the interim document according to a user instruction.

The third-party software edits the interim document, e.g. adds a new character or a new diagram, according to an instruction inputted by a user through a mouse or a keyboard and so on. The new contents edited may be appended above the converted contents (e.g. the OLE object), or after all the converted contents. Taking each page being an OLE object or an image as an example, when the editing generates new contents, the third-party software may generate an object for each page, or generate an object for the whole interim document with the object including a sub-object for each page of the interim document. When the new contents are appended above the converted contents, the editing is performed on an object newly generated for the edited page of the interim document. As for pages where there are no new contents, the objects newly generated for those pages of the interim document remain empty, i.e. there are no contents. Those skilled in the art should be aware that, the above is merely an example. There are various manners for storing the newly edited contents, and different third-party software may adopt different manners.

In order to ensure that the contents of the original document opened will not be modified, the interim document generated can be set as modification prohibited and/or deletion prohibited. Preferably, attributes of the converted objects can be configured in such a manner that modifications by the third-party software to the converted objects will be rejected. For example, the attribute of an embedded object or an image in the interim document may be set as locked, which makes the third-party software unable to delete an OLE object or an image object, to change the size of the OLE object or the image object, and to insert new contents between two objects.

In step 206, when the third-party software performs a saving operation, the plug-in converts the new contents edited by the third-party software into a format conforming to the docbase standard and adds the converted new contents into the original document opened.

In this step, when the document is saved, the new contents edited by the third-party software may be converted using the virtual printing technique into contents in the format of the original document. Then the converted contents are saved into the original document to form a new document conforming to the docbase standard (referred to as new document hereinafter for short).

The virtual printing technique is a technique for generating a document through a virtual printing interface. Since the technique can obtain document information without parsing the format of the document, it supports all kinds of formats that can be printed. A high-quality virtual printer functions like a real printer. Software can select it as the printer for printing a document and carry out the print operation. The difference relies in that the virtual printer does not need hardware support, and the printing generates a document. This technique is widely used and will not be described further herein.

In practice, the third-party software may trigger the plug-in to save the edited new contents as a new UOML document by using the virtual printing technique. Then the plug-in merges the new UOML document and the original UOML document utilizing a UOML interface according to position relationships between the edited new contents and objects converted from the original UOML document. In particular, the plug-in may invoke a printing function of the third-party software to parse the edited new contents and generate data for printing. Herein, each page of the new contents can be a unit of the data for printing. If there are new contents on a page, the data for printing on this page is the new contents. If a page does not have new contents, the printed page is a blank page. The plug-in inputs the data generated for printing into a pre-configured virtual printer. The virtual printer invokes a UOML standard interface for generating the UOML document according to the data for printing and generates the new UOML document. Finally, the newly generated UOML document is merged with the original UOML document. During the combination, it is determined that whether there is a page in the original UOML document corresponding to the page having the edited new contents in the newly generated UOML document. If there is, the corresponding pages in the two documents will be merged into one page, e.g., the page in the newly generated UOML document is saved as a layer of the corresponding page in the original UOML document. If a new page number is added in the newly generated UOML document, the page will be taken as a new page in the merged document. When the contents in the corresponding pages are merged, if the page in the newly generated UOML document is a blank page, i.e. there are no newly edited contents on this page, the page in the original UOML document will be taken as the corresponding page in the merged document. If there are data contents on the page of the newly generated document, i.e. there are newly edited contents on this page, the page in the newly edited document will be taken as a new layer of the corresponding page in the original UOML document. As such, the UOML document generated contains both the contents of the original UOML document and the edited new contents.

Alternatively, the edited new contents may be directly converted into document contents in UOML format utilizing the virtual printing technique. Based on the original UOML document, the new contents are inserted in corresponding position of the original UOML document. In particular, the third-party software parses the edited new contents and generates data for printing. Similar to the above, each page takes as a unit of the data for printing. The plug-in inputs the data for printing and information of the original UOML document into a pre-configured virtual printer. Herein, the information of the original UOML document may be a storage path of the original UOML document. The virtual printer obtains contents of the original UOML document according to the received information of the original UOML document, compares the UOML document with the data for printing generated from the edited new contents. If the page number of a page having the edited new contents exists in the original UOML document, it is determined that the user has added contents to the page of the original UOML document. The virtual printer creates a layer for the page in the original UOML document and saves the new contents added to the page in the layer newly created. If the page number of a page having edited new contents does not exist in the original UOML document, it is determined that the user has inserted a new page at the end of the original UOML document and has added certain new contents in the new page. The virtual printer adds a new page at the end of the original UOML document and saves the new contents into the page.

In step 207, the new contents in the interim document or the interim document can be embedded into the original document as a source document in the format of the interim document.

In order to get the new edited contents in the format of the interim document, the new edited contents can be saved in the format of the interim document. For example, save newly edited contents in an RTF document in the format of the RTF document. Then, the newly edited contents saved in the format of the interim document are embedded into the original document as a source file.

If the document is saved in this manner, next time when opening the UOML document, the third-party software can directly obtain the source file saved in the UOML document without the conversion again. The source file in the interim format can be directly displayed, while other contents in the UOML document will be converted and displayed according to the method described in steps 201 to 204.

Generally, when the edited UOML document is opened and displayed, the source file saved last time, in the format of the interim document (e.g. the RTF format), is obtained from the UOML document. Other contents of the UOML document except the source file are converted, and then an interim document, is formed and merged with the source file (the merged document are in format of the interim document). The third-party software opens the merged document and displays the merged contents. During this procedure, the documents merged for opening and displaying may be interim documents generated after latest N times of edit and the original document before the N times of edit.

Besides the above opening manner, next time when opening the edited UOML document, the third-party software may open all contents of the UOML document edited in step 205 (or saved in step 206) following the manner described in steps 201-204.

The foregoing descriptions are only preferred embodiments of this invention and are not for use in limiting the protection scope thereof. Any changes and modifications can be made by those skilled in the art without departing from the scope of this invention and therefore should be covered within the protection scope as set by the appended claims.

1. A method for processing a document conforming to a docbase standard, comprising:
obtaining contents of a document conforming to a docbase standard via a docbase standard interface;
generating an interim document which is in a format supported by a third-party software, converting contents of each page of the document into an embedded object or image, and saving the embedded object or image into the interim document; and
providing the interim document for the third-party software for displaying.

2. The method of claim 1, wherein the third-party software displays the interim document by invoking a presentation software to parse and display the at least one embedded object and/or directly displaying at least one image.

3. The method of claim 2, wherein saving the contents of the document into the interim document as at least one embedded object comprises:
storing position information of the contents of the document into the at least one embedded object, wherein the position information of the contents of the document is a link of the contents of the document;
wherein, invoking a presentation software to parse and display the at least one embedded object comprises:
obtaining, by the presentation software, data of the contents of the document according to position information stored in the at least one embedded object; and
parsing and displaying the data.

4. The method of claim 2, wherein saving the contents of the document into the interim document as at least one embedded object comprises:
storing data of the contents of the document into the at least one embedded object;
wherein, invoking a presentation software to parse and display the at least one embedded object comprises:
obtaining, by the presentation software, the data of the contents of the document stored in the at least one embedded object, and
parsing and displaying the data.

5. The method of claim 2, wherein saving the contents of the document into the interim document as at least one image comprises:
obtaining layout information of the contents of the document via a docbase standard interface, saving the layout information as the at least one image, and storing the at least one image in the interim document;
wherein directly displaying at least one image comprises:
drawing, by the third-party software, the at least one image in the interim document.

6. The method of claim 1, the docbase standard interface is based on the document model obtained by modeling the appearance information of documents.

7. The method of claim 1, further comprising:
setting the attribute of the at least one embedded object and/or image in the interim document as locked.

8. The method of claim 1, further comprising:
merging, after the third-party software editing the interim document, the newly edited contents into the document by invoking the docbase standard interface.

9. The method of claim 8, wherein merging the newly contents into the document comprises:
creating a new layer of the document, and saving the newly edited contents into the newly created layer; or
saving the newly edited contents into a new document conforming to the docbase standard, and merging the new document with the document.

10. The method of claim 9, wherein, virtual printing technique is adopted to save the newly edited contents into the newly created layer or into the new document conforming to the docbase standard.

11. The method of claim 9, wherein merging the new document with the document comprises:
when there is a page in the document corresponding to a page in the new document, saving the page of the new document as a new layer of the corresponding page of the document;
when there is not any page in the document corresponding to a page in the new document, saving the page of the new document as a new page of the document.

12. The method of claim 8, further comprising:
embedding the interim document edited into the document; or
embedding the newly edited contents into the document in a format of the interim document.

13. The method of claim 12, further comprising:
obtaining the interim document embedded into the document and providing the interim document for the third-party software for displaying; or
obtaining the contents of the document except the newly edited contents and the newly edited contents in interim document format embedded into the document, generating a second document in a format supported by the third-party software based on the contents of the document, merging the second document with the newly edited contents into the second interim document, and providing the second interim document to the third-party software for displaying.

14. The method of claim 1, wherein the contents of the document comprises: contents of specific layers or specific edition of the document.

15. An apparatus for processing a document conforming to a docbase standard, comprising a processor coupled to a memory storing instructions for execution by the processor, and further comprising:
a first module, adapted to obtain contents of a document conforming to a docbase standard via a docbase standard interface;
a second module, adapted to generate an interim document in a format supported by the third-party software and save the contents of the document into the interim document as at least one embedded object and/or image, convert contents of each page of the document into an embedded object or image, and save the embedded object or image into the interim document;
a third module, adapted to provide the interim document for a third-party software for displaying.

16. The apparatus of claim 15, further comprising:
a fourth module, adapted to merge, after the interim document is edited by the third-party software, newly edited contents into the document by invoking the docbase standard interface.

17. The apparatus of claim 16, wherein the fourth module comprises:
a unit, adapted to create a new layer in the document for the newly edited contents, and save the newly edited contents into the newly created layer by invoking a virtual printer; or save the newly edited contents into a new document conforming to the docbase standard by invoking a virtual printer and merge the new document with the document.

18. The apparatus of claim 15, further comprising:
a fifth module, adapted to embed, after the interim document is edited by the third-party software, the edited interim document or newly edited contents in a format of the interim document, into the document.

19. The apparatus of claims 15, wherein the apparatus is a plug-in pre-configured in the third-party software or a set of software independent of the third-party software.

20. A non-transitory computer-readable medium having instructions stored thereon that when executed cause a computing system to process a document conforming to a docbase standard by:
obtaining contents of a document conforming to a docbase standard via a docbase standard interface;
generating an interim document which is in a format supported by the third-party software, and converting contents of each page of the document into an embedded object or image, and saving the embedded object or image into the interim document; and
providing the interim document for a third-party software for displaying.
